(19) United States
(12) Patent Application Publication
(10) Pub. No.: US 2011/0177485 A1
(43) Pub. Date: Jul. 21, 2011

(54) House to transform images of ideas. space, earthquake housing

(76) Inventor: James Timothy Struck, Chicago, IL (US)

(21) Appl. No.: 12/688,837

(22) Filed: Jan. 15, 2010

(51) Int. Cl. G09B 25/00

(52) U.S. Cl. 434/365

(57) ABSTRACT

House to transform images of ideas and space, earthquake housing allows image changes from outside image to different ideas inside. Paper is folded into form of house with external sign and internal elements. Paper is cut in corners in form of square with cut paper removed from corners. Examples of how invention is used relating freedom sign outside house to slavery through too much rights expression, guardianship sign outside to slavery through rights restrictions, doctor sign outside and internal elements such as healing, shots, consultation, accepting difference, Nobel prize to internal elements, Unknown having internal elements of life, cosmology, love, and user determined image and internal images. Sun external idea with internal elements like heliosphere, magnetic storms, etc. Rolled paper can be unrolled, cut corners, folded for housing, forming box, with outside idea and internal ideas including corner paper cut outs for fuel, heat, food, bedding.

### CROSS-REFERENCE TO RELATED APPLICATIONS

Related to provisional application applied for on Sep. 16, 2008. I claim relationship to provisional application filed by me on Sep. 16, 2008 and also utility application Ser. No. 12/558,056 filed on Sep. 11, 2009. Those applications are being abandoned primarily because of cost savings.

Related to earlier applications “Transformation Imaging, Freedom Slavery House” Provisional application 9/2008 and utility application Ser. No. 12/558,056 Transformation Imaging Freedom Slavery House Toy or device for creating image transformations from one image to other images specifically for Sun, Stars, Guardianship, Freedom, Land Of Lincoln, Unknown, Medical Treatment, and User Defined Transformations. Also providing minimal housing on moons, planets, asteroids, other locations from rolled and cut out paper applied for on Sep. 11, 2009.

There is federal sponsorship of my difficulties dealing with discrimination and abuse of persons with disabilities under guardianship and persons under the control of health care systems against their wills, denied phone, visitation, fresh air from second hand smoking, consent, what chemicals are used, religious services, dental services, caregiver reimbursement, right to make personal decisions in states like Illinois, and most nations and states of the world, under guardianship. Slavery like guardianship creates trauma and stress which government provides some support for responding to. Still, specifically with regard to the patent application, there is no support of the specific application. I am currently using a library at Northwestern University. There is probably some federal support for the library. Requests for federal assistance from NASA, DOD, USGS, USDA, HUD, NIH etc. were made but not granted so far.

No research agreement and no materials on compact disc

### BACKGROUND OF THE INVENTION

1. Field of the Invention

Discusses area of toys, housing, image, idea transformation, educational models, educational dioramas, interplanetary housing, and housing, idea transformation, earthquake response

2. Background Art

Many dioramas, models, toys exist currently, but this invention gives some of the changes involved in an idea or concept. I was forced to change the name from transformation imaging to House to transform images of ideas. Space, Earthquake Housing as there were 45 patent applications using the word transformation imaging and one application U.S. Pat. No. 5,101,157 Nagashima, et al. Mar. 31, 1992

Fourier Transformation Imaging Method

Inventors:

Nagashima; Mitsunobu (Katsuta, JP), Takeda; Ryuzaburo (Mito, JP) Which used the word transformation imaging. I therefore changed the title to a more accurate and more related to the provisional application “House to transform images of ideas. Space, Earthquake Housing” My invention is not about centering an image in the center of a display, but rather about studying the association and displaying the association between one idea and other related ideas and providing a minimal amount of housing with some possible food, sheet and fuel in the corners of the pieces of paper or made from the pieces of paper.

For the housing area, prior art includes Buckminster Fuller Housing, concepts we associate with flop houses, shanty towns, native American housing in Tepees and housing seen during the Great Depression after people lost homes during dust bowls. This housing is an improvement as it can be made of a paper or other material in which a box can be made over the person rather than wood which might damage forests in the area. The housing can be transported to another planet, moon, or other location very easily. Rolled housing can be stored in a small place. Its purpose can be housing not from available materials in area. Its material can be suited to needs of the region involved not wood in the region involved. Unlike origami, this invention specifies taking paper from corners of paper for signs and external images. Origami involves similar processes, but not with regard to external signs and internal images and to image transformation in concepts or ideas about the world.

Boxes in shanty towns involve similar ideas, but not with regard to sign from corners and internal images from corners cut out. Housing in space, earthquake housing here is unique versus boxes as a method for making the house is specified. The internal elements can be used to designate issues in the house such as ideas being conceptualized. The external sign can designate what is inside a house. The rolled paper format is an easier transportation method with other elements.

Dioramas are a currently used technology to study something or an idea. This invention is technology to study an idea with a simple method of conveying the association between a concept and other concepts. Museum dioramas are critical to understanding topics in museums (see displays at museums such as Smithsonian Museum of Natural History, Field Museum, Milwaukee Museum, Cincinnati Museum of Natural History). This invention gives a way of displaying one idea and its relationship with other ideas. The display of ideas and their converse idea in a house format can be simply transported, easily looked at, easily study associations, used as a toy, used to understand ideas that people have about an idea like the Sun, Lincoln, guardianship, slavery, Nobel prize associated ideas, freedom or the unknown.

Placing food, sheet and fuel between 2 slips of paper can provide an easy way to provide housing in a situation like a disaster or earthquake, distant planet or asteroid. The paper structure can be easily shipped long distances without using much space versus current housing methods which are cumbersome and hard to ship.

### BRIEF SUMMARY

Images are transformed with a box like piece of paper formed from a piece of paper, with corners cut off to show transformation from one concept to another from external sign to internal images. Housing can be transported to other planets or locations by unrolling a piece of paper and forming a box for housing. The cut out corners provide food, sheet, fuel. We can transform from one concept about something to another concept about something. We can study transformations in images from one concept to another converse or opposite concept. The device can help see the transformation of images about the world, Universe and its ideas. On a planet, moon or elsewhere the pieces of paper, cut from corners, can provide fuel, sheet, or food. The external sign cut from corner can tell what or who is inside.

### BRIEF VIEWS OF DRAWINGS

The drawings describe folding and cutting the paper to form a box, internal elements and external sign. Drawings also discuss housing paper which unrolled and cut to provide housing, make sign, and provide internal elements. Shows ease of transport. Shows some examples of specific elements discussed, Stars, guardianship, doctors, Land of Lincoln, unknown, and user defined elements. Shows corners used for sheet, fuel, food. Fuel, sheet and food can be placed in corners of piece of paper for ease of shipment.

### DETAILED VIEW OF DRAWINGS

### Specifications

Paper is cut from any paper source to amount for which you can bend four sides down to form a house with flat roof. Signs are cut from paper source corners to place external to house. Paper is cut from paper source corners to describe internal elements of house. Device helps image transformation from outside to inside.

Paper from corners can be eaten or burned to provide food, sheet or heat.

Making or Using the Invention

### Example 1 Nobel Prize Concepts Studied

Invention can be used to study associations between Nobel Prize and other concepts related to what won the Nobel Prize.

See this article written by me on Sep. 6, 2009 that different perspectives on the Nobel Prize are just as significant as what was awarded the Nobel Prize. The design can include Nobel Prize on piece of paper outside the house as a sign and converse or opposite or different images inside.

This is related prior background art as it teaches the need to image the converse of the original image and shows a way of making or using the invention to look at a Nobel Laureate's external concept as a sign outside the house and internal elements inside the house for different concepts than what the Nobel Laureate was awarded their prize for—

This invention provides a house to transform images of ideas like the Nobel Prize. One can use the invention to look at transformation from the concepts that received the Nobel Prize to other different concepts and ideas.

Sep. 6, 2009 article-Every year the Nobel Foundation sends out invitations to “scholarly academies, scientists, university professors, previous Nobel laureates, members of parliaments and other assemblies and other assemblies, and others, requesting nominations for the various prizes.” “The Alfred B. Nobel Prizes are widely regarded as the world's most prestigious awards given for intellectual achievement.” (Time Almanac, p. 91, 2008) While the award does recognize noble activity, the prize could be associated with asking people to be perfect, noble or ideal rather than be people, different or somehow defective. One might have to litigate extensively to visit family, get fresh air from second hand smoke, use phone, live with family, know where family is, take family to religious services/zoos/museums/doctors/outside, know chemicals used on family members, because your expression or speech is not perfect, ideal or noble enough in a culture where noble and special actions are awarded recognized. One image of something can be more important than other images of something. Many regions of the world, including Lincoln related Illinois, really do use past medical treatment, disability, illness, incapacity, medication use to take away the rights to decide and resources of persons. Nursing homes and hospitals sometimes give shots without consent to people that make it hard for them to move, talk or write. Concerns about these shots without consent are met with restrictions on access, denial of phone use, denial of visitation, denial of fresh air from second hand smoke, death threats from nursing home staff. If one is not perfect in all ways, regions like Illinois and Cook County may use difference to take away everything from people. It may not be a coincidence that Illinois with many Nobel Prizes also may take away the rights to decide and resources of people with incapacity or disabilities. If one does not meet Illinois and Cook County's view of normal, Illinois and Cook County may take all you have and your right to decide. Regions with many Nobel Prizes were previously involved in this as well-Germany and France had many Nobel Laureates in the 1930's. Illinois coincidentally is also the headquarters of Boeing involved in past and present wars; Cook County and Illinois courts retaliate against concerns with Illinois' involvement in these wars. In addition, look at how many of the Nobel Prizes in Peace could be awarded to the converse or opposite concern. The other image is just as important as the awarded image. The sign outside is associated with other concepts or ideas inside on slips of paper from the corners of the house.

Yunus/Grameen Bank, instead prize awarded to persons concerned about lending giving rise to debt International Atomic Energy Agency, instead prize awarded to those who want to produce nuclear power in more places for energy or are concerned with solar, water, pendulum, geological, coal, animal, oil, wind, or chemical energy or concerned with nuclear wastes

Wangari Maathai, instead prize awarded to those who want to limit tree planting to limit forest fires in certain areas, trees as a weed sometimes, and are concerned with soil erosion when trees are planted

Shirin Ebadi, instead prize awarded to someone who thinks democracy, such as what happened in National Socialist Germany and Italy where fascism was brought into power through elections, is harmful

Jimmy Carter, instead prize awarded to someone who thinks that the Camp David talks put too much emphasis on discussion between leaders and not peace amongst people or someone concerned that Carter did not include a Palestinian representative or a person who supports anarchy or monarchy and not elections Kofi Annan, United Nations, instead prize awarded to people who think nations, regions, families and local solutions to problems can protect against international organizations and government taking away rights

Kim Dae Jung, instead awarded to someone who thinks a Korean Museum is a better Solution than negotiations or someone who thinks Kim Il Jong appropriately is concerned with his people' right to feed themselves

Sign Outside House

Doctors without Borders

Internal elements inside instead awarded to someone who thinks medicine is involved in rights violations, violations of liberty, confining people against their will, shots without consent, not releasing chemicals put into people, loss of rights under guardianship or nursing home systems similar to slavery or concentration camps. Someone concerned that Illinois and some other states may take away the rights to decide and resources of persons with disabilities. Any kind of other images or ideas inside the house

External Sign

Jody Williams, Internal pieces of paper instead awarded to those who believe landmines can protect against tanks and other weapons

External Sign Outside House

Martin Luther King,

Internal elements inside house instead awarded to those who non-violently advocate that people have a right to segregate, separate and isolate themselves sometimes (historically black or women colleges or schools) and that we should not judge people by character or any Characteristic or someone who thinks that non violently abiding by orders and laws and discussing the problematic law or order was a better approach to non violent resistance than possibly violating some problematic law

External Sign

Charles Dawes,

Internal elements instead prize awarded to someone who thinks Germany should pay no reparations, because harms were done by all parties in World War I and that reparations and conferences can distract from issues involved

External Sign

Theodore Roosevelt,

Internal elements on pieces of paper cut from corners instead Prize awarded to someone who thinks Theodore was involved in harmful activities in Cuba, Panama, shooting wildlife like Pandas and Philippines

External Sign Outside House

Woodrow Wilson,

Internal images inside house cut from corners of piece of paper instead Prize awarded to someone who thinks not creating new states and reparations would decrease war in future, someone who thinks peace congresses and peace efforts can cause conflict in some cases George Marshall, instead prize awarded to someone concerned about abuses of civilians by General Marshall and allied forces during World War II John Mather, George Smoot, Arno Penzias, and Robert Wilson, instead prize awarded to someone who thinks that the CMBR and Big Bang connection is not proven, CMBR just as likely a local phenomena, even if universal . . . . CMBR not closely related to Big Bang, dipole remnant should not exist as many galaxies are moving around, and CMBR more importantly described as temperature measurement, and wrong emphasis as associated with cosmology better as temperature measurement other radiations just as much relics of Big Bang

The Nobel Prize, although a wonderful way to recognize the work of someone, can just as easily recognize the work of those opposed to the Laureates concerns or opposite concerns or issues. Perhaps that is the beauty of the award recognizing contributions by people who sometimes recognize the value of the ideas they are opposed to, non-violent approaches (like Dr. King), issues they are talking about and other side of the issues they are concerned about or talking to.

Nobel prize opposite concerns can be one of the transformed images in this application. These specific transformations can be part of the house to transform images of ideas specifically illustrated with external sign such as the Nobel Prize as it was awarded and internal elements inside cut from corner pieces of paper inside opposite or converse concerns.

Other perspectives and ideas, such as these distinct ideas about opposite Nobel Prizes, are not often included in dioramas, models, images, toys. This device emphasizes the other perspective from one idea to another idea from one concept to others. My article provides prior art by this inventor that other perspectives and nobility examples should be used. Not including the other side includes problems such as abuse of the different idea or concepts. Including the different concept allows the other concept not to be discriminated against.

### Example 2 Freedom Concept Studied

Freedom house can transform inside into slavery through too much expression of freedom. If every freedom is expressed, people can be abused as a result. Freedom can justify many crimes.

### Example 3 Guardianship Concept Studied

Guardianship can transform into slavery and confinement through too much rights restrictions by guardians or ignoring or denying rights/liberties of those controlled. Guardianship can mean all rights and resources lost or also mean defense against abuse and exploitation. Guardianship can be described as a religiously related phenomena, problem with health care, like slavery, many different descriptions. These are all placed on paper strips cut from corners of piece of paper.

Positive Guardianship Image Transforms to—

Guardianship can deny visitation, deny phone use, deny fresh air from second hand smoking, Deny where family is, deny consent to treatment, deny chemicals used on people, Deny religious services, deny going to dentists/museums/zoos/outside, deny going home, reunions, birthday, Christmas services. In Chicago area, when nursing home director says “you are going to be dead” after I request fresh air from second hand smoke and express concern with mother's shaking Hands, related to shots without consent hospitals and nursing home gave her, Cook County guardian staff limits access, visitation, phone use, coming home. Nursing home gives shots that cause moving, talking, writing limitations. Image transformation can transform our images of guardianship, from angel guardian or watching over, and other concepts. Cook County Guardian staff, or guardians throughout the world, may deny mail, medical records, and dental, food, optical, prescription, transportation bills to make money for the state or nation. These are issues that some guardians in Illinois really do deny. We can transport from a positive image of guardianship to a negative image of guardianship denying rights to make money.

We can transform from a negative image of guardianship to one of guardianship protecting from abuse, neglect, exploitation, financial difficulty or loss of resources, defending from far away complaints, defending from exploitation or defending interest of the person.

### Example 4 Land of Lincoln Concept studied

External Sign Cut from Corner Piece of Paper

Land of Lincoln has elements in house cut from corner piece of paper of museums, sites, Mary Todd, Lawyer, Lincoln bed, lawyer, astronomy research, Lincoln Douglas debates, persons locked in slavery through guardianship or crime in nursing homes or prisons. These concepts are cut from corners of paper. Sign or image Land of Lincoln cut from corner of paper and placed internal to house, other state slogans or mottos.

### Example 5 Unknown Studied or Looked at

External Sign

Unknown has sign for unknown and internal elements cut from corner pieces of paper of characteristics of unknown sets such as imagination, dreams, hate, ghosts, mystery, God, gods, devil, angels, prayer, healing, sickness, illness, friendship, being, love, time, becoming, death, Universe, origins.

### Example 6 Doctor Studied

External Sign Cut from Corner Pieces of Paper

Doctor's house has internal elements cut from corner pieces of paper of treatment, surgery, shots, consultation, speech, listening, loss of some rights in some states like for mental illness and disability in several regions under probate act, referral, billing, tests, procedures, feeling, hearing, measuring, laboratories, fear, trust, healing, health improvement, and user created elements.

(Consultation is a word contributed to by Jane Frances Back Struck, who guardianship limits me from asking if she approves of word. I will try to ask her sometime soon if she approves of use of her name. With office action may need to remove credit to her if she does not approve of use of her word consultation.)

### Example 6 User Determined House Ideas

Variable house allows for external sign creation and user created elements to describe the Transformation from outside external sign idea to inside other internal ideas from the pieces of paper in the corners of the paper

### Example 7 To Provide Crisis or Astronomical Housing

All above elements may have completely different user created themes or ideas to place in house.

Astronomical and housing significance is house is easily transported. Cylinder rolled paper is foldable into house with user created elements describing internal house characteristics and sign.

Rolled bendable paper allows delivery in compressed form. Easy to transport, unroll, Cut corners, bend down to form house inexpensively or quickly. One can use corners to make sign and internal characteristics of house.

Corners can be eaten or burned, provide fuel or to provide a bed cover for the body.

There are obvious problems with this type of housing. This type of housing can be seen as offensive in being shanty town like without toilets or running water, but still there is some housing provided. As in the case of recent Armenian, Indonesian, Chinese, Haitian earthquakes, some minimal housing can have some value to shield from rain, cold, snow, water, flooding, hail, heat. Fold a piece of paper or other material to make a box with a sign and internal descriptions of house cut from the corners of the pieces of paper. Take from corners of piece of paper fuel, food or sheet to help provide comfort in the house. Fuel, food, or sheet can be made from paper in corners or placed inside the pieces of paper similar to sewn inside. For example, to provide a place for the food, fuel, or sheet we could place an apple or pizza or bread in between two pieces of paper. Compress the two pieces of paper together and the bread is in between. The bread, food, fuel, sheet is placed in between the 2 pieces of paper in the corners of the paper.

### Example 8 Studying Solar Concepts

Could map even Sun. Sun is sign on house and internal characteristics are placed on pieces of paper in house. Person can imagine transformation from perceived freedom outside sun to limitations inside Sun.

Sun external image transforms to internal elements such as Alfven waves, plasma, chromosphere, corona, flare, sunspots, heliosphere, magnetic storms, sunspots, heliopause, heating, H, He, Fe 56, solar cycle, solar movement, solar collisions, stellar collisions, Sun pushing asteroids and planets away with Solar wind, Sun related to religious ideas, Sun as a God, Sun as gods, Sun giving rise to life, Sun 5 billion year history, Sun dying, Sun extending to area of Mars as Red Giant, Sun decreasing intensity associated with Maunder, 2008-09 and Sporer minimum, Sun heating associated with slavery through decreased temperature leading to changes in movement of Northern European peoples possibly, Sun associated with insects and animal life, Sun associated with Magnetic storm Sun associated with heating and cooling, Sun causing UV light, Sun causing cancer, Sun Causing vitamin D formation etc

All these are cut from corners of piece of paper and placed inside Sun transformed image. House to transform images of ideas can be used in many areas, from

### Example 9 Study of Wheelchairs

External sign cut from corner pieces of paper wheelchair outside to Internal elements cut from corner pieces of paper of tool to decrease diaphragm or hernia irritation inside, tool to carry something, tool to decrease cough, tool to sit, tool to rest feet, tool to provide back support, tool to provide support for arms, what Delano Roosevelt was associated with, and something that sometimes is discriminated against inside as disability has historically been associated with loss of freedoms in some areas under guardianship or other control systems such as confinement in nursing homes or hospitals.

This type of transformation can be imaged with this design application, wheelchair on piece of paper outside and these other elements inside on other slips of paper.

House to transform images of ideas space, earthquake housing can be used to provide some minimal housing during earthquakes or away from this galaxy, planet or solar system. This invention also transforms from one idea to other ideas about a concept and provides a way to present their association and study their association.

1. Imaging system with 4 corners cut off from rectangular paper 4 sides of paper folded down forms house image with external sign idea cut from corners inside house other ideas on paper cut from corners

2. Display and education method about guardianship, slavery, freedom, doctors, Land of Lincoln, Sun, stars, Unknown, user determined ideas, Nobel Prize consisting of Folding piece of paper into box house a house with external image or sign for house or idea subject and description of different ideas on paper pieces cut from corners placed inside folded house imaging external sign idea to internal ideas

3. Paper housing by unrolling rolled square or rectangular paper cutting 4 corners from paper and folding paper sides down and placing external sign cut from corners sheet, food, fuel between corners of 2 pieces of paper and sheet, food, fuel inside housing cut from 4 corners
